(19) United States
(12) Patent Application Publication
(10) Pub. No.: US 2024/0286469 A1
(43) Pub. Date: Aug. 29, 2024

(54) DOOR TRIM MODULE

(71) Applicant: KOJIMA INDUSTRIES CORPORATION, Toyota-shi, Aichi-ken (JP)

(72) Inventors: Shunpei AKAHANE, Toyota-shi, Aichi-ken (JP); Naokatsu NOGUCHI, Toyota-shi, Aichi-ken (JP); Haruhiko YOSHIDA, Toyota-shi, Aichi-ken (JP); Yuusuke OGAWA, Toyota-shi, Aichi-ken (JP); Yousuke YAMAMOTO, Toyota-shi, Aichi-ken (JP); Tatsuhiko IKUMA, Toyota-shi, Aichi-ken (JP); Satoshi KAWAMURA, Toyota-shi, Aichi-ken (JP); Kimitaka KURAMOTO, Koyota-shi, Aichi-ken (JP); Hisashi HUTATSUYA, Toyota-shi, Aichi-ken (JP); Nobuaki TAKAHASHI, Toyota-shi, Aichi-ken (JP)

(73) Assignee: KOJIMA INDUSTRIES CORPORATION, Toyota-shi, Aichi-ken (JP)

(21) Appl. No.: 18/566,464

(22) PCT Filed: Jun. 2, 2021
(86) PCT No.: PCT/JP2021/020934

§ 371 Date: Dec. 1, 2023

(51) Int. Cl. B60J 5/04; B60R 11/02

(52) U.S. Cl. CPC B60J 5/0493; B60R 11/0241

(57) ABSTRACT

A USB jack is provided below a bulging part of a door trim. Therefore, the bulging part can prevent rainwater from entering the USB jack. As a result, the USB jack can be provided on the door trim. In addition, since a connection hole is provided in the bulging part, a USB cable can be arranged to extend from an internal space of a storage part to a lower space of the bulging part through the connection hole. As a result, although the USB jack is provided below the bulging part, the USB jack and a smartphone stored in the storage part can be connected by the USB cable.

### CROSS-REFERENCE TO RELATED APPLICATIONS

The present application is a 35 U.S.C. § 371 U.S. National Phase entry of, and claims priority to, PCT Application PCT/JP2021/020934 filed Jun. 2, 2021, which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates to door trim modules for a side door of a vehicle.

JP h09-086251 A discloses a technique where a door trim of a side door of a vehicle includes a bulging part bulging toward a vehicle cabin side such that the bulging part has a storage part capable of housing an article therein. An internal space of the storage part is open to the vehicle cabin side, in addition to the upside.

JP 2019-031252 A and JP 2017-114309 A disclose techniques where a door trim of a side door of a vehicle includes a bulging part bulging toward a vehicle cabin side such that the bulging part has a storage part capable of housing a smartphone therein.

However, such conventional door trims have a following problem. Each door trim does not have a USB jack configured to be connected to a USB (Universal Serial Bus) cable. Accordingly, when the smartphone is placed in the storage part, it is difficult to connect the smartphone to the USB jack by using the USB cable.

JP 2019-001348 A and JP 2016-120886 A disclose techniques where a USB jack is formed on an interior member of a vehicle. However, J P 2019-001348 A and JP 2016-120886 A do not disclose a technique where the USB jack is formed on a door trim.

It should be noted that it would be difficult to provide a USB jack on the door trim for the following reasons. (I) Rainwater may enter the USB jack when the door is open. (II) When closing the open door, the USB cable may be sandwiched between the door and the vehicle body. Therefore, there has been a need for improved door trim modules.

### SUMMARY

In one aspect of the present disclosure, a door trim module includes a door trim and a USB jack. The door trim includes a bulging part bulging toward a vehicle cabin side. The bulging part has an upper surface, a lower surface, and a storage part. The storage part is recessed from the upper surface and is configured to house at least a portion of a smartphone in an internal space thereof. The USB jack is positioned below the bulging part. The bulging part defines a connection hole extending in a vertical direction to connect the internal space to a lower space of the bulging part such that a USB cable can be inserted into the connection hole.

### BRIEF DESCRIPTION OF DRAWINGS

FIG. 1 is a perspective view of a door trim module according to an embodiment of the present disclosure.

FIG. 2 is a front view of the door trim module according to the embodiment of the present disclosure.

FIG. 3 is an enlarged plan view of a storage part and its vicinity in the door trim module of the embodiment of the present disclosure, in which a USB cable is omitted.

FIG. 4 is an enlarged cross-sectional view taken along line A-A of FIG. 1.

FIG. 5 is a cross-sectional view taken along line B-B of FIG. 3.

FIG. 6 is an exploded perspective view of a bulging part and a plate of the door trim module according to the embodiment of the present disclosure.

FIG. 7A is a schematic perspective view of the plate of the door trim module of the embodiment of the present disclosure, prior to insertion of a USB cable into a hole in the plate.

FIG. 7B is a schematic perspective view of the plate of the door trim module of the embodiment of the present disclosure after the USB cable has been inserted into the hole in the plate.

FIG. 7C is a schematic perspective view of the plate of the door trim module of the embodiment of the present disclosure in a state where the USB cable is inserted into the hole in the plate and then is moved downwardly relative to the plate.

FIG. 8 is an enlarged, partial perspective view of the storage part and its vicinity in the door trim module according to the embodiment of the present disclosure.

FIG. 9 is an enlarged cross-sectional view taken along line C-C of FIG. 8.

FIG. 10 is an enlarged cross-sectional view taken along line D-D of FIG. 8.

FIG. 11 is an enlarged cross-sectional view taken along line E-E of FIG. 2.

FIG. 12 is an enlarged cross-sectional view taken along line F-F in FIG. 2.

### DETAILED DESCRIPTION

Referring to the drawings, a door trim module 10 according to an embodiment of the present disclosure will be described. It should be noted that, in the drawings, UP indicates an upper side of a vehicle, FR indicates a front side of the vehicle, and IN indicates a vehicle cabin side.

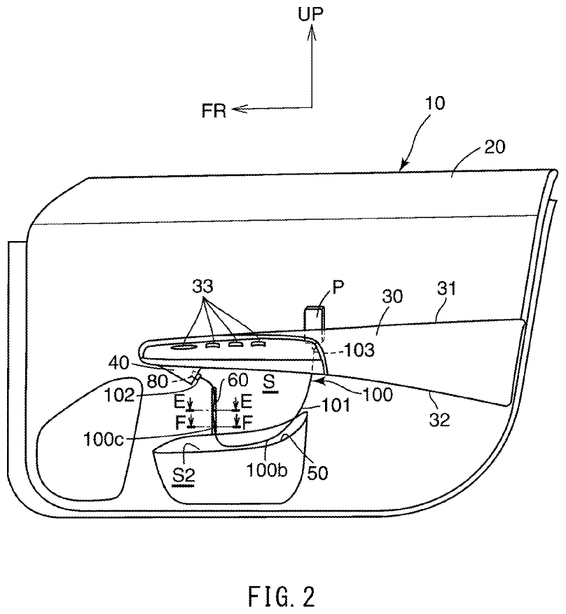

The door trim module 10 is attached to the vehicle cabin side of a side door (not shown) of the vehicle. As shown in FIG. 2, the door trim module 10 includes a door trim 20 and a USB jack 80 (also referred to as USB port).

The door trim 20 includes a bulging part 30, a protrusion 40, and a cable housing 50.

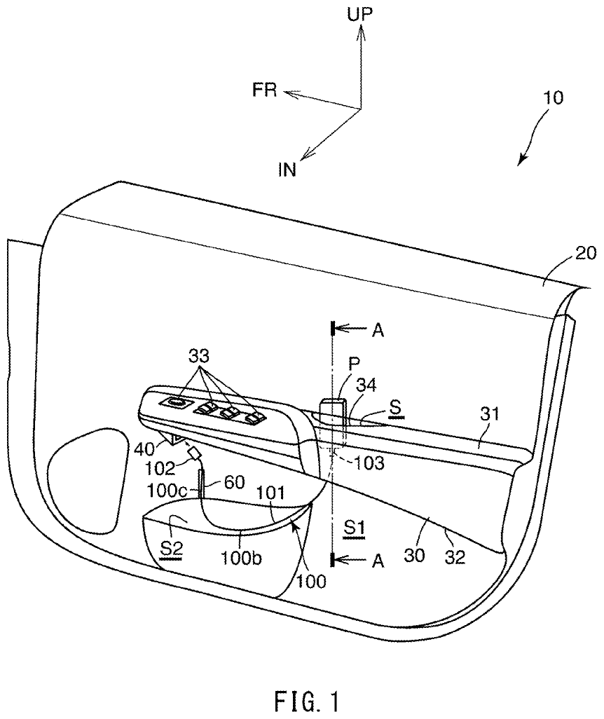

As shown in FIG. 1, the bulging part 30 is bulged toward the vehicle cabin side and has an upper surface 31, a lower surface 32, and a storage part 34. The bulging part 30 extends in the longitudinal direction of the vehicle at an intermediate portion in the vertical direction of the door trim 20. The bulging part 30 may be solid or hollow. At least a part of the bulging part 30 can be used as an armrest. The upper surface 31 of the bulging part 30 includes some switches 33, such as power window switch.

As shown in FIG. 2, the protrusion 40 is formed at or near a front end of the lower surface 32 of the bulging part 30 based upon the vehicle orientation. The protrusion 40 is shaped to protrude downward from the lower surface 32. The protrusion 40 may be integrally formed with the bulging part 30 and may be formed separately from the bulging part 30. The protrusion 40 is not visible behind the bulging part 30 when viewed from above.

The USB jack 80 is formed on the protrusion 40. Since the USB jack 80 is provided on the protrusion 40, the USB jack 80 is positioned below the bulging part 30. The USB jack 80 is open toward the rear side or toward the rearward lower side based on the vehicle orientation. The USB jack 80 can be connected to a USB cable 100 prepared by an occupant (not shown).

The USB cable 100 includes a cable part 101, a jack-side connector 102 disposed at one longitudinal end of the cable part 101 and configured to be connected to the USB jack 80, and a phone-side connector 103 disposed at the other longitudinal end of the cable part 101 and configured to be connected to the smartphone P.

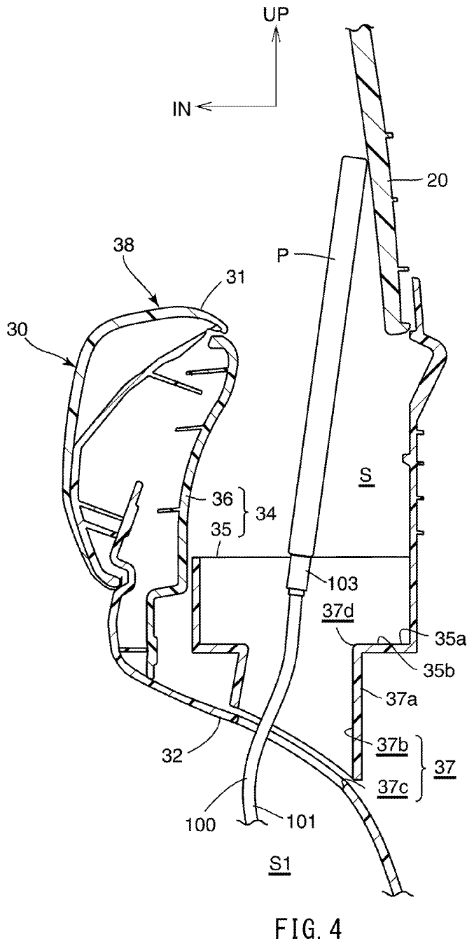

As shown in FIG. 4, the storage part 34 is formed in the bulging part 30 and is recessed downward from the upper surface 31 to house at least a part of the smartphone P in an internal space S of the storage part 34. The storage part 34 is formed on the rear side of the switches 33 in the vehicle longitudinal direction. The storage part 34 is positioned on the rear side of the USB jack 80 in the vehicle longitudinal direction. Since the storage part 34 is formed in the bulging part 30, a part of the bulging part 30 on the vehicle cabin side of the internal space S is a pull handle 38 that can be gripped by the occupant. The storage part 34 has a bottom wall 35 and a side wall 36. The internal space S of the storage part 34 is open upward.

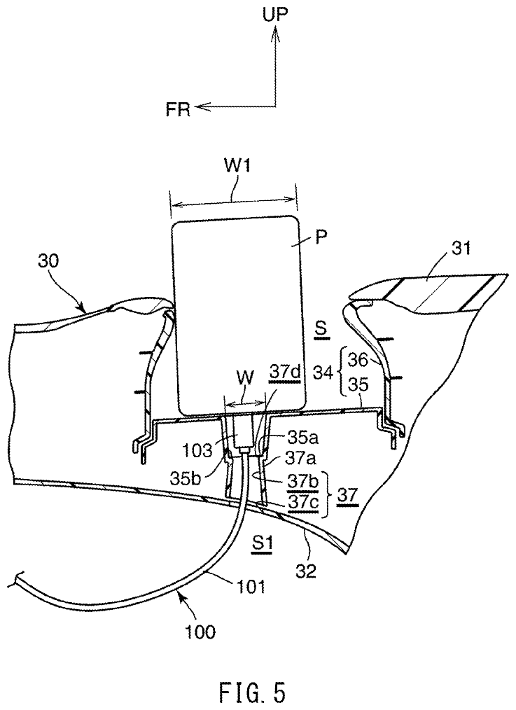

As shown in FIGS. 4 and 5, the bulging part 30 has a connection hole (communication passage) 37 that extends in the vertical direction to connect the internal space S of the storage part 34 to a lower space S1 below the bulging part 30. The USB cable 100 can be inserted into the connection hole 37. The connection hole 37 comprises an inner space 37b of a downwardly extending part 37a integrally formed with the bottom wall 35 of the storage part 34 and extending downward from the bottom wall 35, and a through hole 37c penetrating the lower wall of the bulging part 30.

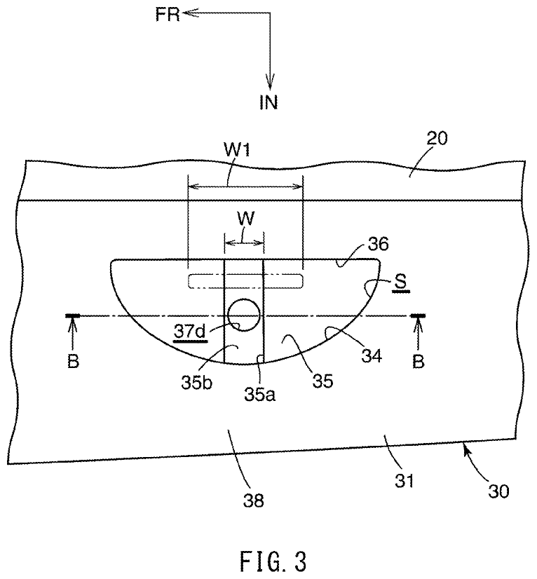

A recess 35a recessed downward is formed in the bottom wall 35 of the storage part 34. As shown in FIG. 3, the recess 35a extends over the whole length or substantially the whole length of the bottom wall 35 in the vehicle width direction. As shown in FIG. 5, the recess 35a is configured to receive the phone-side connector 103 of the USB cable 100. Thus, when the phone-side connector 103 of the USB cable 100 is connected to the smartphone P, the phone-side connector 103 can be placed within the recess 35a.

The width W of the recess 35a is shorter than the width W1 of the smartphone P (the length in the width direction orthogonal to the longitudinal direction and the thickness direction). Therefore, the smartphone P is prevented from entering (falling down) into the recess 35a.

An upper opening 37d, which is an opening of the connection hole 37 on the internal space S side, is formed at the bottom surface 35b of the recess 35a.

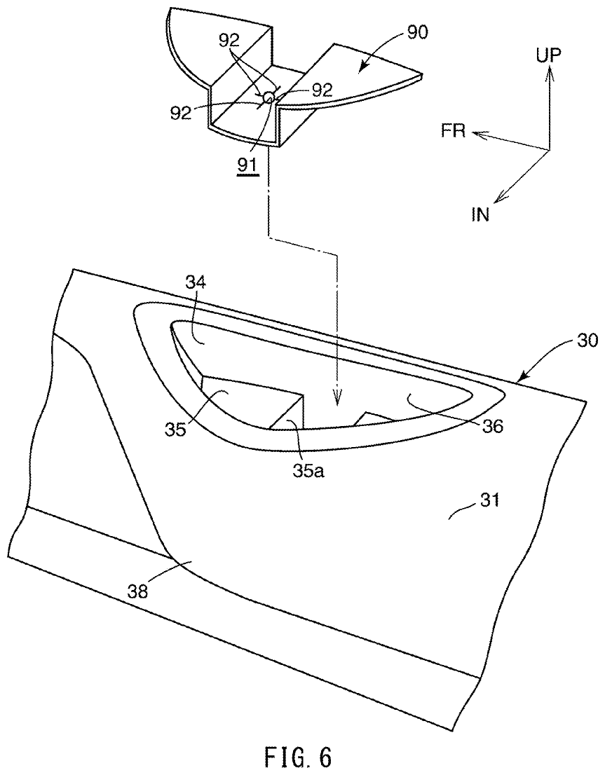

As shown in FIG. 6, a plate 90 may be mounted on the bottom wall 35 of the storage part 34. The plate 90 has a substantially same shape as the bottom wall 35 of the storage part 34. The plate 90 is made of an elastic resin, such as rubber. The plate 90 is formed separately from the bottom wall 35 of the storage part 34. The plate 90 has a hole 91 having a smaller diameter than the upper opening 37d of the connection hole 37, and at least one slit 92 extending radially outward of the hole 91 from the hole 91.

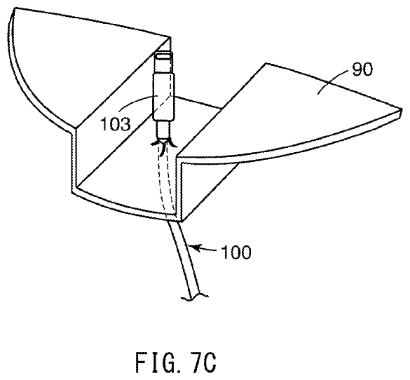

As shown in FIG. 8, a first groove 36a, into which a portion 100a of the USB cable 100 in the longitudinal direction can be fitted, is formed in the side wall 36 of the storage part 34. At least one first projection 36c projecting into the first groove 36a and ending in the first groove 36a is formed on a wall surface 36b defining the first groove 36a.

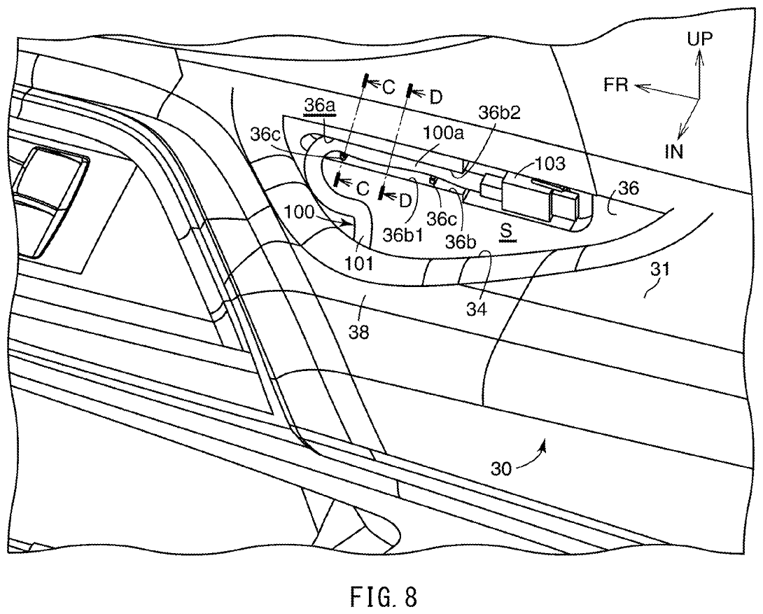

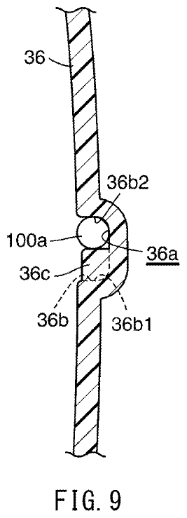

As shown in FIGS. 9 and 10, the wall surface 36b defining the first groove 36a has a pair of wall surfaces 36b1, 36b2 facing each other in a direction orthogonal to the longitudinal direction of the first groove 36a. The first projections 36c are formed on one wall surface 36b1 and the other wall surface 36b2 of the pair of wall surfaces 36b1 and 36b2 of the first groove 36a, at positions shifted from each other in the longitudinal direction of the first groove 36a. In other words, the first projections 36c formed on the wall surface 36b1 and the first projections 36c formed on the wall surface 36b2 are not disposed at the same position in the longitudinal direction of the first groove 36a. The first projections 36c are arranged alternately on the one wall surface 36b1 and the other wall surface 36b2 of the pair of wall surfaces 36b1, 36b2 of the first groove 36a in the longitudinal direction of the first groove 36a.

As shown in FIG. 2, the cable housing 50 is formed below the USB jack 80. A longitudinal intermediate portion 100b of the USB cable 100 may be inserted into an internal space S2 of the cable housing 50.

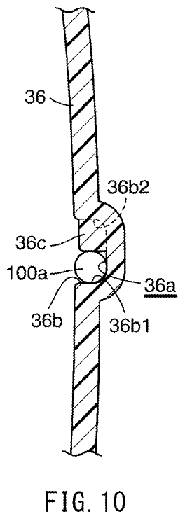

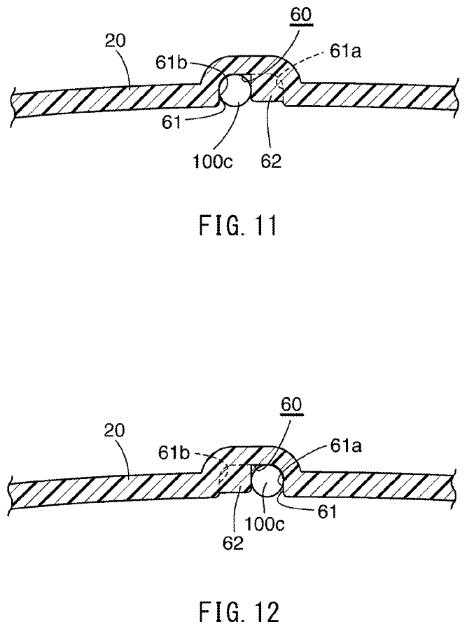

In the door trim 20, a second groove 60, into which a portion 100c of the USB cable 100 in the longitudinal direction can be fitted, is formed below the USB jack 80 and above the cable housing 50. The portion 100c of the USB cable 100 is a different portion than the portion 100a of the USB cable 100 in the longitudinal direction of the USB cable 100. As shown in FIGS. 11 and 12, at least one second projection 62 projecting into the second groove 60 and ending in the second groove 60 is formed on a wall surface 61 defining the second groove 60.

The wall surface 61 defining the second groove 60 has a pair of wall surfaces 61a, 61b facing each other in a direction orthogonal to the longitudinal direction of the second groove 60. The second projections 62 are formed on one wall surface 61a and the other wall surface 61b of the pair of wall surfaces 61a and 61b of the second groove 60, at positions shifted from each other in the longitudinal direction of the second groove 60. In other words, the second projections 62 formed on the one wall surface 61a and the second projections 62 formed on the other wall surface 61b are not disposed at the same position in the longitudinal direction of the second groove 60. The second projections 62 are arranged alternately on the one wall surface 61a and the other wall surface 61b of the pair of wall surfaces 61a and 61b of the second groove 60 in the longitudinal direction of the second groove 60.

Next, actions and effects of the embodiments of the present disclosure will be described.

(A) Since the USB jack 80 is positioned below the bulging part 30 of the door trim 20, the bulging part 30 can prevent rainwater from entering the USB jack 80. Thus, it is possible to form the USB jack 80 on the door trim 20. Further, since the bulging part 30 has the connection hole 37, the USB cable 100 can be arranged to extend from the internal space S of the storage part 34 to the lower space S1 of the bulging part 30 through the connection hole 37. Thus, even when the USB jack 80 is formed on the lower side of the bulging part 30, the smartphone P stored in the storage part 34 can be connected to the USB jack 80 by the USB cable 100.

(B) Since the USB jack 80 is open toward the rear side or toward the rearward lower side based on the vehicle orientation, it is possible to suppress rainwater from entering the USB jack 80 in comparison with a case where the USB jack 80 is open upward from the horizontal direction. Furthermore, the USB cable 100 can be easily connected to the USB jack 80 in comparison with a case where the USB jack 80 is open vertically downward.

(C) Since the portion of the bulging part 30 on the vehicle cabin side of the internal space S is the pull handle 38, the usability of the bulging part 30 can be improved.

(D) The recess 35a is formed at the bottom wall 35 of the storage part 34. The upper opening 37d, which is the opening of the connection hole 37 on the internal space S side, is formed at the bottom surface 35b of the recess 35a. Accordingly, in a state where the phone-side connector 103 of the USB cable 100 is connected to the smartphone P, the phone-side connector 103 can be located in the recess 35a.

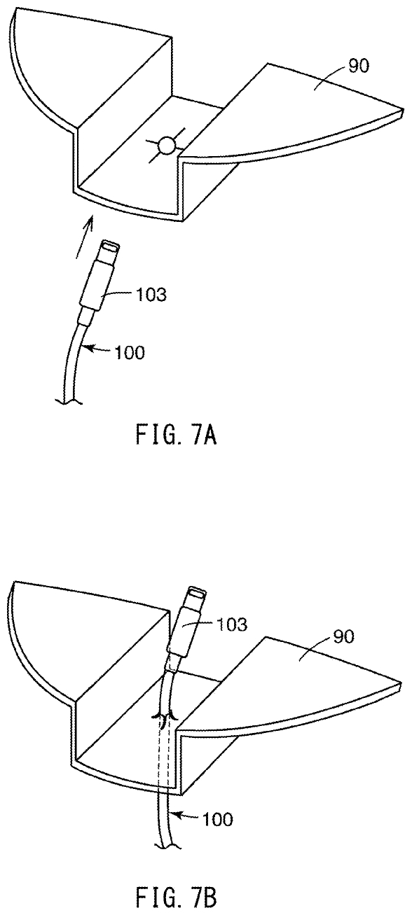

(E) As shown in FIGS. 7A to 7C, the elastic resin plate 90 has the hole 91 having the smaller diameter than the upper opening 37d of the connection hole 37 and at least one slit 92 extending radially outward of the hole 91 from the hole 91. Accordingly, even when the diameter of the hole 91 of the plate 90 is smaller than the diameter of the phone-side connector 103 of the USB cable 100, the diameter of the hole 91 can be increased by deforming the peripheral edge of the hole 91 to allow the phone-side connector 103 to be passed through the hole 91. After the phone-side connector 103 is passed through the hole 91, the peripheral edge of the hole 91 is restored. Accordingly, the phone-side connector 103 is caught by the peripheral edge of the hole 91, thereby preventing the phone-side connector 103 from falling out of the storage part 34 through the hole 91.

(F) The side wall 36 of the storage part 34 has the first groove 36a, into which the portion 100a of the USB cable 100 in the longitudinal direction can be fitted. Thus, when the USB cable 100 is not in use, the USB cable 100 can be held by the wall surface 36b defining the first groove 36a by fitting the portion 100a of the USB cable 100 located in the internal space S into the first groove 36a. Accordingly, while the USB cable 100 is not in use and the bulging part 30 is in use, it is possible to suppress the USB cable 100 from being obstructive.

(G) The wall surface 36b defining the first groove 36a includes at least one first projection 36c projecting into the first groove 36a. Accordingly, the holding force for the USB cable 100 can be increased in comparison with the case where the first projection 36c is not provided.

(H) The first protrusions 36c are formed on the one wall surface 36b1 and the other wall surface 36b2 of the pair of wall surfaces 36b1, 36b2 of the first groove 36a, respectively, at different positions in the longitudinal direction of the first groove 36a, thereby effectively increasing the holding force for the USB cable 100.

(I) Since the door trim 20 has the cable housing 50, into which the longitudinal intermediate portion 100b of the USB cable 100 can be inserted, below the USB jack 80, the longitudinal intermediate portion 100b of the USB cable 100 can be placed in the internal space S2 of the cable housing 50. Therefore, even when the USB cable 100 is relatively long, the USB cable 100 can be prevented from being caught between the door and the vehicle body when the open door is closed.

(J) The door trim 20 has the second groove 60, into which the portion 100c of the USB cable 100 in the longitudinal direction can be fitted, below the USB jack 80. Thus, the USB cable 100 can be held on the wall surface 61 defining the second groove 60 by fitting the portion 100c of the USB cable 100 located below the bulging part 30 into the second groove 60. Accordingly, it is possible to suppress the USB cable 100 from being obstructive when using the cable housing 50.

(K) The wall surface 61 defining the second groove 60 has at least one second projection 62 protruding into the second groove 60. Accordingly, the holding force for the USB cable 100 can be increased in comparison with the case where the second projection 62 is not provided.

(L) The second projections 62 are formed on the one wall surface 61a and the other wall surface 61b of the pair of wall surfaces 61a and 61b of the second groove 60, with their positions shifted from each other in the longitudinal direction of the second groove 60, thereby effectively increasing the holding force for the USB cable 100.

The present disclosure is not limited to the above-described embodiments and can be modified without departing from the scope of the claimed inventions.

The present disclosure discloses various aspects of the technology. A first aspect is a door trim module including a door trim and a USB jack. The door trim includes a bulging part bulging toward a vehicle cabin side. The bulging part has an upper surface, a lower surface, and a storage part. The storage part is recessed from the upper surface and is configured to house at least a portion of a smartphone in an internal space thereof. The USB jack is positioned below the bulging part. The bulging part defines a connection hole extending in a vertical direction to connect the internal space to a lower space of the bulging part such that a USB cable can be inserted into the connection hole.

A second aspect is the door trim module of the first aspect, wherein the door trim includes a protrusion projecting downward from the lower surface of the bulging part. The USB jack is formed on the bulging part. The USB jack is open toward a rear side, or a rearward lower side of a vehicle.

A third aspect is the door trim module of the first aspect, wherein a portion of the bulging part on the vehicle cabin side of the internal space is a pull handle that can be gripped by an occupant.

A fourth aspect is the door trim module of the first aspect, wherein a recess downwardly recessed is formed at a bottom wall of the storage part, and wherein an upper opening, which is an opening of the connection hole on an internal space side, is formed at a bottom surface of the recess.

A fifth aspect is the door trim module of the fourth aspect, wherein a plate is formed separately from the bottom wall of the storage part to be mounted on the bottom wall and is made of an elastic resin. The plate has a hole having a smaller diameter than the upper opening of the connection hole and at least one slit extending radially outward of the hole from the hole.

A sixth aspect is the door trim module of the first aspect, wherein a first groove into which a portion of the USB cable in a longitudinal direction can be fitted is formed in a side wall of the storage part.

A seventh aspect is the door trim module of the sixth aspect, wherein a wall surface of the first groove has at least one first projection projecting into the first groove.

An eighth aspect is the door trim module of the seventh aspect, wherein the wall surface of the first groove includes a pair of wall surfaces facing each other in a direction orthogonal to a longitudinal direction of the first groove, and wherein the first projections are formed on one wall surface and the other wall surface of the pair of wall surfaces, respectively, at different positions in the longitudinal direction of the first groove.

A ninth aspect is the door trim module of the first aspect, wherein the door trim includes a cable housing, into which a longitudinal intermediate portion of the USB cable can be inserted, below the USB jack.

A tenth aspect is the door trim module of the ninth aspect, wherein a second groove into which a portion of the USB cable in a longitudinal direction can be fitted is formed on the door trim at a position below the USB jack and above the cable housing.

An eleventh aspect is the door trim module of the tenth aspect, wherein a wall surface of the second groove has at least one second projection projecting into the second groove.

A twelfth aspect is the door trim module of the eleventh aspect, wherein the wall surface of the second groove includes a pair of wall surfaces facing each other in a direction orthogonal to a longitudinal direction of the second groove. The second projections are formed on one wall surface and the other wall surface of the pair of wall surfaces, respectively, at different positions in the longitudinal direction of the second groove.

1. A door trim module, comprising:
a door trim; and
a USB jack, wherein:
the door trim includes a bulging part bulging toward a vehicle cabin side, the bulging part having an upper surface, a lower surface, and a storage part;
the storage part is recessed from the upper surface and is configured to house at least a portion of a smartphone in an internal space thereof;
the USB jack is positioned below the bulging part; and
the bulging part defines a connection hole extending in a vertical direction to connect the internal space to a lower space of the bulging part such that the connection hole allows a USB cable to be inserted thereinto.

2. The door trim module of claim 1, wherein:
the door trim includes a protrusion projecting downward from the lower surface of the bulging part;
the USB jack is formed on the bulging part; and
the USB jack is open toward a rear side, or a rearward lower side of a vehicle.

3. The door trim module of claim 1,
wherein a portion of the bulging part on the vehicle cabin side of the internal space is a pull handle configured to be gripped by an occupant.

4. The door trim module of claim 1, wherein:
a bottom wall of the storage part includes a recess downwardly recessed therefrom; and
an upper opening, which is an opening of the connection hole on an internal space side, is formed at a bottom surface of the recess.

5. The door trim module of claim 4, further comprising
a plate that is made of an elastic resin and is formed separately from the bottom wall of the storage part to be mounted on the bottom wall,
wherein the plate has a hole having a smaller diameter than the upper opening of the connection hole and at least one slit extending radially outward from the hole.

6. The door trim module of claim 1,
wherein a first groove is formed in a side wall of the storage part to allow a portion of the USB cable to be fitted thereinto.

7. The door trim module of claim 6,
wherein a wall surface of the first groove includes a first projection projecting into the first groove.

8. The door trim module of claim 7, wherein:
the wall surface of the first groove includes a second projection projecting into the first groove;
the wall surface of the first groove includes a first surface part and a second surface part facing each other in a direction orthogonal to a longitudinal direction of the first groove; and
the first projection is formed on the first surface part and the second projection is formed on the second surface part such that positions of the first projection and the second projection in the longitudinal direction of the first groove are different from each other.

9. The door trim module of claim 1,
wherein the door trim includes a cable housing below the USB jack to house a longitudinal intermediate portion of the USB cable in the cable housing.

10. The door trim module of claim 9,
wherein a second groove is formed on the door trim at a position below the USB jack and above the cable housing to allow a portion of the USB cable to be fitted within the second groove.

11. The door trim module of claim 10,
wherein a wall surface of the second groove includes a first projection projecting into the second groove.

12. The door trim module of claim 11, wherein:
the wall surface of the second groove includes a second projection projecting into the second groove;
the wall surface of the second groove includes a first surface part and a second surface part facing each other in a direction orthogonal to a longitudinal direction of the second groove; and
the first projection is formed on the first surface part and the second projection is formed on the second surface part such that positions of the first projection and the second projection in the longitudinal direction of the second groove are different from each other.
